(19) United States
(12) Patent Application Publication
(10) Pub. No.: US 2019/0384879 A1
(43) Pub. Date: Dec. 19, 2019

(54) METEOROLOGY SENSITIVE LOAD POWER ESTIMATION METHOD AND APPARATUS

(71) Applicants: STATE GRID JIANGSU ELECTRIC POWER CO., LTD., Jiangsu (CN); STATE GRID CORPORATION OF CHINA, Beijing (CN); STATE GRID JIANGSU ELECTRIC POWER COMPANY RESEARCH INSTITUTE, Jiangsu (CN); HOHAI UNIVERSITY, Jiangsu (CN)

(72) Inventors: Jijun Yin, Jiangsu (CN); Qing Chen, Jiangsu (CN); Zheng Wu, Jiangsu (CN); Xiao Lu, Jiangsu (CN); Jianyu Luo, Jiangsu (CN); Lin Liu, Jiangsu (CN); Jingbo Zhao, Jiangsu (CN); Ping Ju, Jiangsu (CN); Yanxiang Chen, Jiangsu (CN); Chuan Qin, Jiangsu (CN); Jiajun Shi, Jiangsu (CN); Shiwu Liao, Jiangsu (CN); Xinyao Zhu, Jiangsu (CN); Dajiang Wang, Jiangsu (CN)

(73) Assignees: STATE GRID JIANGSU ELECTRIC POWER CO., LTD., Jiangsu (CN); STATE GRID CORPORATION OF CHINA, Beijing (CN); STATE GRID JIANGSU ELECTRIC POWER COMPANY RESEARCH INSTITUTE, Jiangsu (CN); HOHAI UNIVERSITY, Jiangsu (CN)

(21) Appl. No.: 16/440,389

(22) Filed: Jun. 13, 2019

(30) Foreign Application Priority Data
Jun. 13, 2018 (CN) 201810606900.9
May 22, 2019 (CN) 201910430705.X

(51) Int. Cl. G06F 17/50

(52) U.S. Cl. CPC G06F 17/5018

(57) ABSTRACT

Provided are a method and apparatus for estimating a meteorology sensitive load power. The method includes: obtaining a meteorology sensitive load power estimation model; inputting a daily load curve of a date to be estimated to the meteorology sensitive load power estimation model and extracting a daily load curve dimension reduction feature of the date to be estimated; and outputting a meteorology sensitive load power based on the daily load curve dimension reduction feature of the date to be estimated and mapping relationships from daily load curve dimension reduction features onto meteorology sensitive load powers. The proposed estimation model can directly obtain the meteorology sensitive load power curve from the daily load curve, and is especially applicable to cases where meteorology data is frequently lost in practical applications.

### CROSS-REFERENCES TO RELATED APPLICATIONS

This application claims the priority of China patent application No. 201810606900.9 titled “Method for Estimating Meteorology Sensitive Load Power Based on Stacked Auto-Encoder” filed with the State Intellectual Property Office of the People's Republic of China on Jun. 13, 2018, and the priority of China patent application No. 201910430705.X titled “Meteorology Sensitive Load Power Estimation Method and Apparatus” filed with the State Intellectual Property Office of the People's Republic of China on May 22, 2019, disclosures of all of which are incorporated herein by reference in their entireties.

### TECHNICAL FIELD

The present disclosure relates to the field of power system load forecasting and load power model, and more particularly relates to a method and apparatus for estimating a meteorology sensitive load power.

### BACKGROUND

As global warming continues to intensify and living standards of citizens continue to improve, power consumption of meteorology sensitive loads mainly represented by air conditioners is increasing year by year. In 2017, summer air conditioning power consumption in some areas such as Suzhou has caused abnormal growth of the load. Studying the estimation of meteorology sensitive load power can not only improve the accuracy of the load power model and provide regulatory basis for safe and stable operation of the summer power grid, but also provide a basis for response capability assessment on a demand side, which has important research significance.

Patent application number 201810607600.2 provides a method for estimating a meteorology sensitive load power based on a load-meteorology nonlinear association model; but the model has high requirements on the integrity of load power and meteorology sample data. In practical, meteorology data, especially for a meteorology factor changing curve at a 10-minute sampling interval, can be easily lost. If more meteorology data of the current date is lost, the load-meteorology nonlinear association model cannot be used for estimating the meteorology sensitive load of that date.

### SUMMARY

In view of the above problems, the present disclosure provides a method and apparatus for estimating a meteorology sensitive load power, which is able to directly obtain a meteorology sensitive load power curve by a daily load curve, and is especially applicable to cases where meteorology data is frequently lost in practical applications.

The present disclosure adopts the following solutions.

In a first aspect, embodiments of the present disclosure provide a method for estimating a meteorology sensitive load power, including:

obtaining a meteorology sensitive load power estimation model;

inputting a daily load curve of a date to be estimated to the meteorology sensitive load power estimation model and extracting a daily load curve dimension reduction feature of the date to be estimated; and

outputting the meteorology sensitive load power based on the daily load curve dimension reduction feature of the date to be estimated and mapping relationships from daily load curve dimension reduction features onto meteorology sensitive load powers.

Optionally, obtaining the meteorology sensitive load power estimation model includes:

obtaining the meteorology sensitive load power estimation model by training, and testing the meteorology sensitive load power estimation model.

Optionally, the meteorology sensitive load power estimation model includes a stacked auto-encoder (SAE) model and a fully-connected layer;

where obtaining the meteorology sensitive load power estimation model by training includes:

training the SAE model and the fully-connected layer;

Inputting the daily load curve of the date to be estimated to the meteorology sensitive load power estimation model and extracting the daily load curve dimension reduction feature of the date to be estimated includes:

inputting the daily load curve of the date to be estimated to the SAE model and extracting the daily load curve dimension reduction feature of the date to be estimated.

outputting the meteorology sensitive load power based on the daily load curve dimension reduction feature of the date to be estimated and the mapping relationships from the daily load curve dimension reduction features onto the meteorology sensitive load powers includes:

outputting, by the fully-connected layer, the meteorology sensitive load power based on the daily load curve dimension reduction feature of the date to be estimated extracted by the SAE model and the mapping relationships from the daily load curve dimension reduction features onto the meteorology sensitive load powers.

Optionally, training the SAE model includes:

taking a historical data sample as input and output labels of the SAE model to train a first AE of the SAE model;

taking output of an encoding layer of the first AE as an input label to train a next AE of the SAE model until all AEs of the SAE model have been trained;

wherein a target function for the training is that a mean absolute percentage error (MAPE) of the output of the SAE model with respect to a daily load curve of a corresponding historical data sample is the minimum,

$$MAPE = {\sum }_{i = 1}^{n} \vert \frac{{x}_{i} - {x}_{i}^{′}}{{x}_{i}} \vert \cdot \frac{100}{n} ,$$

where xᵢ is an actual daily load power, xᵢ′ is output of the SAE model, and n is a total number of sample points.

Optionally, training the first AE of the SAE model satisfies the following formula:

h(1)ⁱ=s_{f}(W₁xⁱ+b₁);

where xⁱ is output of the first AE of the SAE model, h(1)ⁱ output of the encoding layer of the first AE, W₁ and b₁ are respectively a weight matrix and a bias matrix, and s_{f} is an activate function;

\hat{x}ⁱ=s_{g}(W₁′h(1)ⁱ+b₁′),

where \hat{x}ⁱ is the output of the first AE of the SAE model, W₁′ and b₁′ are respectively a weight matrix and a bias matrix in reconstruction, and s_{g} is an activate function, in reconstruction;

$${θ}^{*} = argmin \frac{1}{2 N} {( {\sum }_{i = 1}^{N} ‖ {\hat{x}}^{i} - {x}^{i} ‖ )}^{2} ,$$

where \hat{x}ⁱ and xⁱ have a minimum mean squared error, θ* is an optimal fully-connected-layer parameter of the encoding layer and a decoding layer of the first AE, and N is a number of historical data samples.

Optionally, training the fully-connected layer includes:

taking the daily load curve dimension reduction feature of a historical data sample as an input label of the fully connected layer and a meteorology sensitive load power curve as an output label of the fully connected layer, to train the fully connected layer and obtain the optimal fully-connected-layer parameter θ′*, where a corresponding date of the daily load curve dimension reduction feature of the historical data sample is same as that of the meteorology sensitive load power curve;

$${θ}^{′ *} = arg min \frac{1}{2 {N}^{′}} {( {\sum }_{i = 1}^{{N}^{′}} ‖ {O}^{i} - {P}_{W}^{i} ‖ )}^{2}$$

where Oⁱ is output of a last fully connected layer of an ith sample, P_{W}ⁱ is a meteorology sensitive load power of the ith sample, and N′ is a number of dates of fully connected layer training samples.

Optionally, a computation formula of the fully connected layer satisfies

O=R(WI+b);

where I and O are respectively an input vector and an output vector of the fully connected layer, W and b are respectively a weight matrix and a bias matrix of the fully connected layer, and R is an activate function of the fully connected layer.

Optionally, the method further includes:

performing a normalization process on a historical data sample before training the SAE model; and

restoring a normalization calculation result of each sample output by the fully-connected layer after training the fully-connected layer.

In a second aspect, embodiments of the present disclosure provide a apparatus for estimating a meteorology sensitive load power, which includes: a stacked auto-encoder (SAE) model and a fully-connected layer.

The SAE model is configured for inputting a daily load curve of a date to be estimated, extracting a daily load curve dimension reduction feature of the date to be estimated, and inputting the daily load curve dimension reduction feature of the date to be estimated to a fully-connected layer; and

The fully-connected layer is connected to an output end of the SAE model and configured for outputting a meteorology sensitive load power based on the daily load curve dimension reduction feature of the date to be estimated and mapping relationships from daily load curve dimension reduction features onto meteorology sensitive load powers.

Optionally, a number of dimensions of the daily load curve of the date to be estimated is a number of sample points of the daily load curve of the date to be estimated; and a number of dimensions of the meteorology sensitive load power to be estimated is the number of sample points of the daily load curve of the date to be estimated.

Optionally, the SAE model is stacked by multiple AEs, and each of the plurality of AEs includes an encoding layer and a decoding layer.

The fully-connected layer comprises at least one layer.

In a third aspect, an embodiment of the present disclosure provides a method for estimating a meteorology sensitive load power based on a stacked auto-encoder, the method including: adding a multilayer fully-connected layer in an output end of a SAE model, and establishing a meteorology sensitive load power estimation model based on the SAE;

extracting a daily load curve dimension reduction feature by using an unsupervised training method of the SAE, using a meteorology sensitive load power curve as a labelled sample to train the fully-connected layer, to form mapping relationships from daily load curve dimension reduction features onto meteorology sensitive load powers at the fully-connected layer.

The estimation model is composed of two parts: a first part is a transitional SAE and a second part is multiple fully-connected layers stacked at an output end of the SAE.

Input of the estimation model is a daily load curve, a number of input dimensions is a number of sample points of the daily load curve; output of the estimation model is the meteorology sensitive load power and a number of output dimensions is the number of sample points of the daily load curve.

A forward propagation computation formula of the SAE is as follows:

input of a first layer of the SAE being xⁱ, calculating output of an encoding layer of a first AE:

h(1)ⁱ=s_{f}(W₁xⁱ+b₁);

where W₁ and b₁ are respectively a weight matrix and a bias matrix, and s_{f} is an activate function;

outputting by the encoding layer of the SE, and reconstructing an input vector through a decoding layer according to the following formula:

\hat{x}ⁱ=(W₁′h(1)ⁱ+b₁′);

where W₁′ and b₁′ are respectively a weight matrix and a bias matrix in reconstruction, and s_{g} is an activate function in reconstruction;

An unsupervised training method of the SAE is as follows:

training the SAE by using a historical daily daily load curve data sample as input and output labels of the SAE, and calculating an optimal fully-connected-layer parameter θ* of the encoding layer and decoding layer of the AE with a mean squared error of \hat{x}ⁱ calculated by the SAE with respect to the output label xⁱ of the SAE being the minimum;

reserving h(1)ⁱ, using h(1)ⁱ as input and output labels of a next AE, continuing to train the next AE in the above manner, with input of the next AE being h(1)ⁱ, and so on, where the final SAE is stacked by multiple AEs.

A computation formula of the optimal fully-connected-layer parameter θ* of the encoding layer and the decoding layer of the AE is as follows:

$${θ}^{*} = arg min \frac{1}{2 N} {( {\sum }_{i = 1}^{N} ‖ {\hat{x}}^{i} - {x}^{i} ‖ )}^{2} ;$$

where N is a number of training samples.

A forward propagation computation formula of the fully-connected layer is as follows:

O=R(WI+b);

in the formula, I and O are an input vector and an output vector of the fully connected layer respectively, W and b are a weight matrix and a bias matrix of the fully connected layer respectively, and R is an activate function of the fully connected layer.

A supervised training method of the fully-connected layer is as follows:

training by taking a deep layer feature of the daily load curve of a certain date after SAE dimension reduction as input of the fully connected layer, and taking the meteorology sensitive load power curve as the output label of the fully connected layer in a corresponding date, and calculating an optimal fully-connected-layer parameter θ′*:

$${θ}^{′ *} = arg min \frac{1}{2 {N}^{′}} {( {\sum }_{i = 1}^{{N}^{′}} ‖ {O}^{i} - {P}_{W}^{i} ‖ )}^{2} ;$$

in the formula, Oⁱ is output of a last layer of the fully connected layer of an ith sample, P_{W}ⁱ is a meteorology sensitive load power of an ith sample, and N′ is a number of dates of the meteorology sensitive load power.

The meteorology sensitive load power curve for a supervised training of the fully-connected layer is computed by the steps described below.

In step 1: data processing on a total load power and meteorology data of a certain region or a certain transformer station is performed and reordered, and a vertical data sample composed of a total load power and meteorology data of at the same time on the same date in different months is obtained. In step 2: a load-meteorology nonlinear association model among the total load power, the meteorology sensitive load power and various meteorological information is established, and model parameters is identified by using a gradient method.

In step 3, the identified model parameters, longitudinal historical meteorology data and total load power data is substituted into the association model, a longitudinal meteorology sensitive load power curve is calculated, and according to a normal time sequence is arranged to obtain a historical daily meteorology sensitive load power curve.

In step 1, the data processing of the total load power and the meteorology data includes data cleaning, removal of long-term increase of basic load power, correction calculation of various meteorology factors such as temperature accumulation, hysteresis effect and body-sensing temperature and humidity.

The step of correcting the meteorology factors is:

correcting the original temperature based on the temperature accumulation, hysteresis effect, the correction formula is:

T_{DayMod}=(T_{day1}λ_{day1}+T_{day2}λ_{day2})/(λ_{day1}+λ_{day2});

λ_{day1}=1−exp[−exp(T_{day1}−26/6)]

λ_{day2}=1−exp[−exp(T_{day2}−26/6)].

where T_{DayMod} is a correction temperature after considering temperature accumulation effect, T_{day1} is the original temperature of the current date; T_{day2} is a correction temperature of a previous date; λ_{day1} is a correction coefficient of the current date and T_{day2} is a correction coefficient of the previous date.

The step of correcting the meteorology factor of the body-sensing temperature and humidity is:

H_{T}=T_{DayMod}H

T_{DayMod} is a correction temperature after considering temperature accumulation effect, H is relative humidity, H_{T} is a correction value of a humidity factor.

In step 2, the load-meteorology nonlinear association model is:

$${r}_{XY} = \frac{{\sum }_{i = 1}^{n} ( {X}_{i} - \overline{X} ) ( {Y}_{i} - \overline{Y} )}{\sqrt{{\sum }_{i = 1}^{n} {( {X}_{i} - \overline{X} )}^{2}} \sqrt{{\sum }_{i = 1}^{n} {( {Y}_{i} - \overline{Y} )}^{2}}} ;$$

$$Y = \frac{{a}_{1}}{1 + {e}^{- {w}_{1} {T}_{Day mod} + {b}_{1}}} + \frac{{a}_{2}}{1 + {e}^{- {w}_{2} {H}_{T} + {b}_{2}}} ;$$

r_{XY} is a correlation coefficient between the total load power and the meteorology sensitive load, X is the total load power processed and normalized in the step 1, Y is the meteorology sensitive load at the same time of the corresponding X, X̅ and Y̅ are mean values of X and Y curves of a certain sample, i is a serial number of a sampling point, Yᵢ and Yᵢ are the total load power of the ith sampling point of a certain sample processed and normalized in the step 1 and the meteorology sensitive load at the same time. n is a number of sampling points of a single sample, and a₁, a₂, b₁, b₂, w₁ and w₂ are parameters to be identified of the load-meteorology association model T_{DayMod} T_{DayMod} is the correction temperature after considering temperature accumulation effect, H^{T} is a correction value of the relative humidity, a relationship among the meteorology sensitive load Y, the correction temperature T_{DayMod} and the correlation humidity is an extended Sigmoid function.

In step 2, when parameters in the load-meteorology nonlinear association model are identified by using a gradient method, an objective function is established as the maximum value of the correlation coefficient, i.e.,

$$J = min \frac{1}{m} {\sum }_{i = 1}^{m} ( 1 - {r}_{XY}^{i} ) ;$$

in the formula, m is a total number of samples, i is the ith sample, r_{XY}ⁱ is the correlation coefficient between the total load power of the ith sample and the meteorology sensitive load.

In step 3, the identified model parameters, longitudinal corrected meteorology data and power data are substituted into the association model, the meteorology sensitive load power curve Y at the corresponding time of this longitudinal sample is calculated, maximum and minimum values of the meteorology sensitive load power curve Y are normalized and a ratio of the meteorology sensitive load power in the total load power is obtained.

$${ρ}_{weather}^{( j )} = \frac{{Y}^{( j )} - {Y}_{min}}{{Y}_{max} - {Y}_{min}}$$

in the formula, ρ_{weather}^{(j)} is a meteorology sensitive load power ratio of a data in a certain sample, Y^{(j)} is a jth meteorology sensitive load power estimation value Y of a certain sample, and Yₘₐₓ, Yₘᵢₙ are the maximum value and the minimum value of the meteorology sensitive load respectively.

The actual meteorology sensitive load power estimation value is:

P_{weather}=ρ_{weather}·(Pₘₐₓ−Pₘᵢₙ)

Pₘₐₓ and Pₘᵢₙ are the maximum value and the minimum value of the total load power of this sample, ρ_{weather} is the meteorology sensitive load power ratio of this sample at a certain sampling time.

The longitudinal meteorology sensitive load power calculated by the association model is arranged according to a normal time sequence, and a daily meteorology sensitive load power curve arranged horizontally is obtained.

The present disclosure has the following beneficial effects:

the estimation model proposed can directly obtain the meteorology sensitive load power curve from the daily load curve, and is especially applicable to the case where meteorology data is frequently lost in practical applications. The SAE can extract the daily load curve dimension reduction feature without supervision, greatly reducing the number of input neurons of the fully connected layer, thereby greatly reducing network parameters of the fully connected layer and significantly reducing the model training difficulty.

### BRIEF DESCRIPTION OF DRAWINGS

FIG. 1 is a schematic diagram illustrating a meteorology sensitive load power estimation model based on a SAE;

FIG. 2 is a diagram illustrating a comparison between actual total load values and SAE calculation results from July 27 to 30 in example tests; and

FIG. 3 is a diagram illustrating a comparison between computation results of a method in the present disclosure with those of an association model from July 27 to 30 in example tests.

### DETAILED DESCRIPTION

Solutions according to the present disclosure will be described in further detail with reference to the drawings and specific embodiments, so that those skilled in the art can better understand and implement the present disclosure, but the embodiments are not intend to limit the present disclosure.

A stacked auto-encoder (SAE) estimation model uses the SAE unsupervised learning to extract a daily load curve dimension reduction feature, adds a multilayer fully-connected layer in an output end of the SAE, takes the dimension reduction feature as input of the SAE model, and takes an association model or traditional method for calculating the results as an output label of a fully connected layer, and trains the fully connected layer. In practical applications, the estimation model can directly obtain the meteorology sensitive load power curve from a daily load curve, thereby significantly improving the practicality of the method.

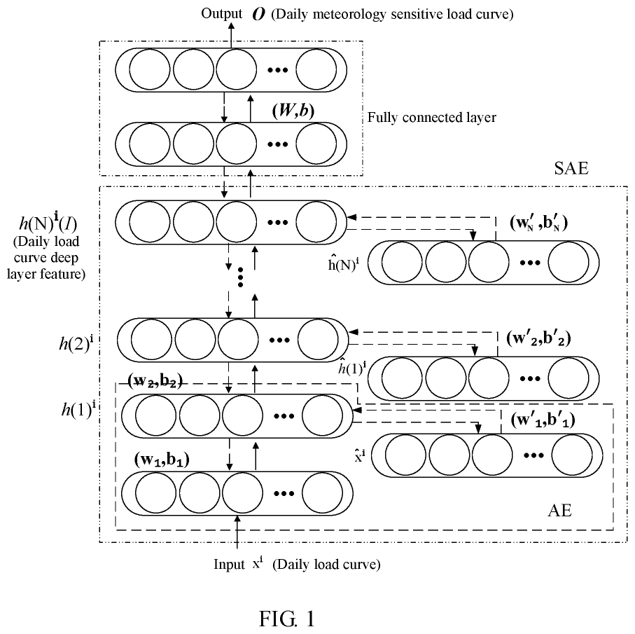

A structure of a meteorology sensitive load estimation model based on the SAE is illustrated in FIG. 1. The model includes the SAE and the fully connected layer. The input of the SAE is a daily load curve, the number of input dimensions is 144, i.e., the number of sample points of the daily load curve. The number of output dimensions of the SAE and the number of encoding and decoding layers are super parameters, and need to be determined in model training and testing. The fully connected layer is located at an output end of the SAE, the number of input dimensions of the full connection layer is consistent with the number of output dimensions of the SAE, and the output of the daily meteorology sensitive load power is 144 points, thereby forming a mapping of a daily load curve deep feature extracted by the SAE onto the meteorology sensitive load power curve.

The model training and the estimation step of the meteorology sensitive load are described below.

1. Unsupervised training is performed on the SAE by taking all daily load curves of April to October in a certain year as samples, thereby performing dimension reduction on the daily load curves and extracting deep features of the daily load curves.

Input of a first layer of the SAE is xⁱ, output of an encoding layer of a first AE is calculated:

h(1)ⁱ=s_{f}(W₁xⁱ+b₁);

where W₁ and b₁ are respectively a weight matrix and a bias matrix, and s_{f} is an activate function.

The above is output by the encoding layer of the SE, and an input vector is reconstructed through a decoding layer according to the following formula:

\hat{x}ⁱ=s_{g}(W₁′h(1)ⁱ+b₁′);

where W₁′ and b₁′ are respectively a weight matrix and a bias matrix in reconstruction, and s_{g} is an activate function in reconstruction.

Then a historical daily daily load curve data sample is used for training, an optimal fully-connected-layer parameter θ* of the encoding layer and a decoding layer of the AE is sought according to the minimum mean squared error of \hat{x}ⁱ and xⁱ, and the computation formula is as follows:

$${θ}^{*} = arg min \frac{1}{2 N} {( {\sum }_{i = 1}^{N} ‖ {\hat{x}}^{i} - {x}^{i} ‖ )}^{2} ;$$

where N is a number of training samples, h(1)ⁱ is reserved, the training of a next AE is continued in the above manner, input of the next AE is h(1)ⁱ, and so on, the final SAE is stacked by multiple AEs.

2. The fully connected layer is trained by taking a calculation result of a calculation method for the meteorology sensitive load power curve as a labelled sample.

A computation formula of the fully connected layer is:

O=R(WI+b);

I and O are an input vector and an output vector of this layer respectively, W and b are a weight matrix and a bias matrix of the fully connected layer respectively, and R is an activate function of the fully connected layer.

An optimal fully-connected-layer parameter θ′* is calculated by training by taking a deep layer feature of the daily load curve of a certain date after SAE dimension reduction as input of the fully connected layer and the meteorology sensitive load power curve as the output label of the fully connected layer in a corresponding date,

$${θ}^{′ *} = arg min \frac{1}{2 {N}^{′}} {( {\sum }_{i = 1}^{{N}^{′}} ‖ {O}^{i} - {P}_{W}^{i} ‖ )}^{2} ;$$

in the formula, Oⁱ is output of a fully connected layer of an ith sample, P_{W}ⁱ is a meteorology sensitive load power of an ith sample, and N′ is a number of dates for which the meteorology sensitive load power may be calculated.

3. After the estimation model is trained, the daily load curve of the date to be estimated is taken as input, and the output of the model is the meteorology sensitive load power curve to be estimated.

### Embodiment One

A certain 220 kV transformer substation in a certain local city is taken as a research object for description of the implementation. The transformer substation includes industrial, commercial, residential and traction loads. The load type is comprehensive. The collected data is 2015 year-round load power of this substation (a sampling interval is 5 minutes), temperature and humidity data (a sampling interval is 10 minutes).

In step 1, sample data is prepared.

Due to incompleteness of meteorology data, a total of 70 pieces of daily meteorology sensitive load power curve data arranged in normal time order (4-10 months, and 10 dates per each month) is calculated, 65 pieces of data are used as labelled samples for training the fully connected layer of the SAE model and another 5 pieces are test samples.

Then 140 pieces of daily load curve data of all working dates of April to October in 2015 (214 dates in total, and includes 69 dates of holidates) are taken as unlabelled samples to train each SAE layer, and another 5 pieces are taken as test samples. The daily meteorology sensitive load power curve arranged in normal time order is calculated from the load-meteorology nonlinear association model.

In step 2, sample data is normalized.

Range normalization is performed on each sample of 70 pieces of meteorology sensitive load power data and 145 meteorology sensitive load data, i.e.,

$${x}_{i}^{′} = \frac{{x}_{i} - {x}_{min}}{{x}_{max} - {x}_{min}} ;$$

in the formula, xᵢ is ith data of a certain sample, xₘᵢₙ and xₘₐₓ are the minimum value and the maximum value of the sample.

In step 3, Unsupervised training is performed on the SAE by taking all daily load curve data of April to October as samples, thereby performing dimension reduction on the daily load curves and extracting deep layer features of the daily load curves. A relative mean absolute percentage error (MAPE) minimum of decoder output and corresponding daily load curve data is taken as a training objective function. A computation formula of MAPE is:

$$MAPE = {\sum }_{i = 1}^{n} \vert \frac{{x}_{i} - {x}_{i}^{′}}{{x}_{i}} \vert \cdot \frac{100}{n} ;$$

xᵢ is an actual daily load power, xᵢ′ is a decoder output value, and n is a total number of sampling points.

After the actual testing, SAE super parameters are finally selected as: four SAE encoding layers and four SAE decoding layers, i.e., performing 4 times of auto-encoding process, and finally daily load data of 144 points is reduced to five deep feature parameters. Through dimension reduction, the number of input dimensions (5 dimensions) and the number of neurons of the fully connected layer are greatly reduced, i.e., the weight and bias parameter to be determined are greatly reduced, which effectively reduces training difficulty of the fully connected layer.

In step 4: the fully connected layer is trained by taking association model calculation results as labelled samples. A daily meteorology sensitive load power curve is calculated by taking the association model as the output label of the fully connected layer. The input sample is a deep layer feature of the daily load curve after SAE dimension reduction, and the trained objective function is the MAPE minimum.

Through the actual testing, two layers of fully connected layer are finally arranged, which respectively including 25 and 144 neurons. The activation function of the first layer is a ReLU function, and the second layer is a tanh function. Therefore, in practice, only two layers of the fully connected layers needs to be trained in the sample labelled with the meteorology sensitive load power curve.

In step 5, a normalization calculation result of each sample output by the complete model is restored:

yᵢ=yᵢ′·(xₘₐₓ−xₘᵢₙ)+xₘᵢₙ;

in the formula, yᵢ′ is normalized meteorology sensitive load power value output by the model, xₘₐₓ and xₘᵢₙ are the maximum actual value and the minimum actual value of the daily load curve sample input by the model.

In step 6, the SAE training result is tested.

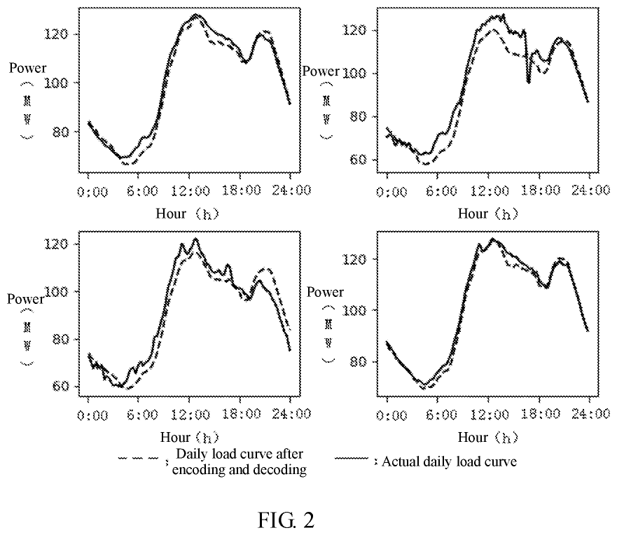

The actual total load power value from July 27-30th is compared with the output curve after SAE encoding and decoding in the testing set, as illustrated in FIG. 2. MAPE values between two curves of each date are calculated separately and a testing error is estimated, as illustrated in the following table:

TABLE 5

| | Date | | | |
|---|---|---|---|---|
| | July 27th | July 28th | July 29th | July 30th |
| MAPE (%) | 1.982 | 4.030 | 3.874 | 1.916 |

It can be seen from the above table and FIG. 2, the power curve after the SAE encoding and decoding highly coincides with the actual load curve, which illustrates that input curve information can be thoroughly reflected when the SAE dimension reduction is performed to extract the deep layer features.

In step 7, a fully connected layer test result is tested.

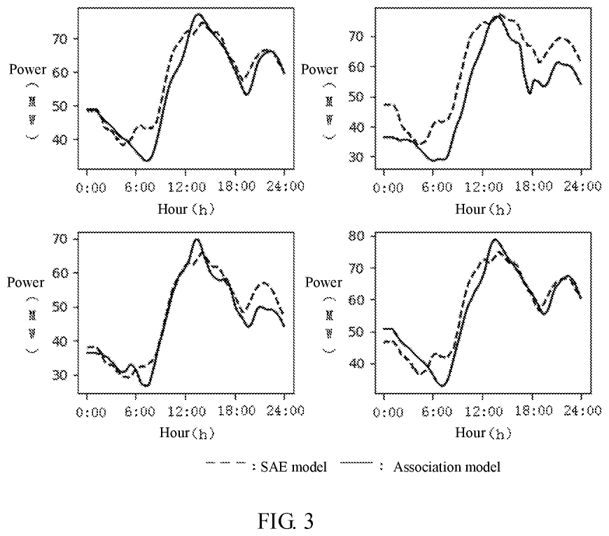

A meteorology sensitive load power carve is compared with an association model result of test samples from July 27-30, as illustrated in FIG. 3.

It can be seen from FIG. 3, the two curves are generally similar. Considering a factor of smaller training sample, the SAE estimation model may approach the association model calculation result, so that the daily meteorology sensitive load power curve may be directly obtained by adopting the SAE estimation model when more meteorology data is lost and the association model is difficult to use.

In step 8, after the estimation model is trained and tested, the daily load curve of a date of the meteorology sensitive load power curve to be estimated is taken as the total input of the model, and the final output of the model is the meteorology sensitive load power curve to be estimated.

The above merely depicts some exemplary embodiments according to the present disclosure, and it should be noted that for those skilled in the art, numerous improvements and modifications can be made without departing from the principle of the present disclosure, where these improvements and modifications shall all fall in the scope of the present disclosure.

What is claimed is:

1. A method for estimating a meteorology sensitive load power, comprising:
obtaining a meteorology sensitive load power estimation model;
inputting a daily load curve of a date to be estimated to the meteorology sensitive load power estimation model and extracting a daily load curve dimension reduction feature of the date to be estimated; and
outputting the meteorology sensitive load power based on the daily load curve dimension reduction feature of the date to be estimated and mapping relationships from daily load curve dimension reduction features onto meteorology sensitive load powers.

2. The method of claim 1, wherein obtaining the meteorology sensitive load power estimation model comprises:
obtaining the meteorology sensitive load power estimation model by training, and testing the meteorology sensitive load power estimation model.

3. The method of claim 2, wherein the meteorology sensitive load power estimation model comprises a stacked auto-encoder (SAE) model and a fully-connected layer;
wherein obtaining the meteorology sensitive load power estimation model by training comprises:
training the SAE model and the fully-connected layer;
wherein inputting the daily load curve of the date to be estimated to the meteorology sensitive load power estimation model and extracting the daily load curve dimension reduction feature of the date to be estimated comprises:
inputting the daily load curve of the date to be estimated to the SAE model and extracting the daily load curve dimension reduction feature of the date to be estimated; and
wherein outputting the meteorology sensitive load power based on the daily load curve dimension reduction feature of the date to be estimated and the mapping relationships from the daily load curve dimension reduction features onto the meteorology sensitive load powers comprises:
outputting, by the fully-connected layer, the meteorology sensitive load power based on the daily load curve dimension reduction feature of the date to be estimated extracted by the SAE model and the mapping relationships from the daily load curve dimension reduction features onto the meteorology sensitive load powers.

4. The method of claim 3, wherein training the SAE model comprises:
taking a historical data sample as input and output labels of the SAE model to train a first AE of the SAE model;
taking output of an encoding layer of the first AE as an input label to train a next AE of the SAE model until all AEs of the SAE model have been trained;
wherein a target function for the training is that a relative mean absolute percentage error (MAPE) of the output of the SAE model with respect to a daily load curve of a corresponding historical data sample is the minimum,
$$MAPE = {\sum }_{i = 1}^{n} \vert \frac{{x}_{i} - {x}_{i}^{′}}{{x}_{i}} \vert \cdot \frac{100}{n} ,$$
where xᵢ is an actual daily load power, x′ᵢ is the output of the SAE model, and n is a total number of sample points.

5. The method of claim 4, wherein training the first AE of the SAE model satisfies the following formula:
h(1)ⁱ=s_{f}(W₁xⁱ+b₁),
where xⁱ is output of the first AE of the SAE model, h(1)ⁱ is the output of the encoding layer of the first AE, W₁ and b₁ are respectively a weight matrix and a bias matrix, and s_{f} is an activate function;
\hat{x}ⁱ=s_{g}(W′₁h(1)ⁱ+b′₁),
where \hat{x}ⁱ is the output of the first AE of the SAE model, W′₁ and b′₁ are respectively a weight matrix and a bias matrix in reconstruction, and W′₁ is an activate function;
$${θ}^{*} = arg min \frac{1}{2 N} {( {\sum }_{i = 1}^{N} ‖ {\hat{x}}^{i} - {x}^{i} ‖ )}^{2} ,$$
where \hat{x}ⁱ and xⁱ have a minimum mean squared error, θ* is an optimal fully-connected-layer parameter of the encoding layer and decoding layer of the first AE, and N is a number of historical data samples.

6. The method of claim 3, wherein training the fully-connected layer comprises:
taking the daily load curve dimension reduction feature of a historical data sample as an input label of the fully connected layer, and a meteorology sensitive load power curve as an output label of the fully connected layer, to train the fully connected layer and obtain the optimal fully-connected-layer parameter θ′*, wherein a corresponding date of the daily load curve dimension reduction feature of the historical data sample is same as that of the meteorology sensitive load power curve,
$${θ}^{′ *} = arg min \frac{1}{2 {N}^{′}} {( {\sum }_{i = 1}^{{N}^{′}} ‖ {O}^{i} - {P}_{W}^{i} ‖ )}^{2} ,$$
where Oⁱ is output of a last fully connected layer of an ith sample, P_{W}ⁱ is a meteorology sensitive load power of the ith sample, and N′ is a number of dates of fully connected layer training samples.

7. The method of claim 6, wherein a computation formula of the fully connected layer satisfies
O=R(WI+b);
where I and O are respectively an input vector and an output vector of the fully connected layer, W and b are respectively a weight matrix and a bias matrix of the fully connected layer, and R is an activate function of the fully connected layer.

8. The method of claim 3, further comprising:
performing a normalization process on a historical data sample before training the SAE model; and
restoring a normalization calculation result of each sample output by the fully-connected layer after training the fully connected layer.

9. An apparatus for estimating a meteorology sensitive load power, comprising a stacked auto-encoder (SAE) model and a fully-connected layer, wherein
the SAE model is configured for inputting a daily load curve of a date to be estimated, extracting a daily load curve dimension reduction feature of the date to be estimated, and inputting the daily load curve dimension reduction feature of the date to be estimated to a fully-connected layer; and
the fully-connected layer is connected to an output end of the SAE model and configured for outputting a meteorology sensitive load power based on the daily load curve dimension reduction feature of the date to be estimated and mapping relationships from daily load curve dimension reduction features onto meteorology sensitive load powers.

10. The apparatus of claim 9, wherein a number of dimensions of the daily load curve of the date to be estimated is a number of sample points of the daily load curve of the date to be estimated; and a number of dimensions of the meteorology sensitive load power to be estimated is the number of sample points of the daily load curve of the date to be estimated.

11. The apparatus of claim 9, wherein
the SAE model is stacked by a plurality of auto-encoders (AEs), and each of the plurality of AEs comprises an encoding layer and a decoding layer; and
the fully-connected layer comprises at least one layer.

12. A method for estimating a meteorology sensitive load power based on a stacked auto-encoder, the method comprising: adding a multilayer fully-connected layer in an output end of a SAE model, and establishing a meteorology sensitive load power estimation model based on the SAE;
extracting a daily load curve dimension reduction feature by using an unsupervised training method of the SAE, using a meteorology sensitive load power curve as a labeled sample to train the fully-connected layer, to form mapping relationships from daily load curve dimension reduction features onto meteorology sensitive load powers at the fully-connected layer.

13. The method of claim 12, wherein input of the estimation model is a daily load curve, a number of input dimensions is a number of sample points of the daily load curve; output of the estimation model is the meteorology sensitive load power, and a number of output dimensions is the number of sample points of the daily load curve.

14. The method of claim 12, wherein a forward propagation computation formula of the SAE is as follows:
input of a first layer of the SAE being xⁱ, calculating output of an encoding layer of a first AE:
h(1)ⁱ=s_{f}(W₁xⁱ+b₁)
wherein W₁ and b₁ are respectively a weight matrix and a bias matrix, and s_{f} is an activate function;
outputting by the encoding layer of the SE, and reconstructing an input vector through a decoding layer according to the following formula:
\hat{x}ⁱ=s_{g}(W₁′h(1)ⁱ+b′₁)
wherein W₁′ and b₁′ are respectively a weight matrix and a bias matrix in reconstruction, s_{g} is an activate function in reconstruction, and h(1)ⁱ is the output of the encoding layer of the first AE.

15. The method of claim 14, wherein an unsupervised training method of the SAE is as follows:
Training the SAE by using a historical daily daily load curve data sample as input and output labels of the SAE, and calculating an optimal fully-connected-layer parameter θ* of the encoding layer and decoding layer of the AE with a mean squared error of \hat{x}ⁱ calculated by the SAE with respect to the output label xⁱ of the SAE being the minimum;
reserving h(1)ⁱ, using h(1)ⁱ as input and output labels of a next AE, continuing to train the next AE in the above manner, with input of the next AE being h(1)ⁱ, and so on, where the final SAE is stacked by a plurality of AEs.

16. The method of claim 15, wherein a computation formula of the optimal fully-connected-layer parameter θ* of the encoding layer and decoding layer of the AE is as follows:
$${θ}^{*} = arg min \frac{1}{2 N} {( {\sum }_{i = 1}^{N} ‖ {\hat{x}}^{i} - {x}^{i} ‖ )}^{2}$$
wherein N is a number of training samples.

17. The method based on a stacked auto-encoder of claim 12, wherein a forward propagation computation formula of the fully-connected layer is as follows:
O=R(WI+b);
where I and O are respectively an input vector and an output vector of the fully connected layer, W and b are a respectively weight matrix and a bias matrix of the fully connected layer, and R is an activate function of the fully connected layer.

18. The method of claim 17, wherein a supervised training method of the fully-connected layer is as follows:
training by taking a deep layer feature of the daily load curve of a certain date after SAE dimension reduction as input of the fully connected layer, and taking the meteorology sensitive load power curve as the output label of the fully connected layer in a corresponding date, and calculating an optimal fully-connected-layer parameter θ*:
$${θ}^{′ *} = arg min \frac{1}{2 {N}^{′}} {( {\sum }_{i = 1}^{{N}^{′}} ‖ {O}^{i} - {P}_{W}^{i} ‖ )}^{2}$$
where Oⁱ is output of a last layer of the fully connected layer of an ith sample, P_{W}ⁱ is a meteorology sensitive load power of an ith sample, and N′ is a number of dates of the meteorology sensitive load power.

19. The method of claim 17, wherein the meteorology sensitive load power curve for a supervised training of the fully-connected layer is computed by the following steps:
performing data processing on a total load power and meteorology data of a certain region or a certain transformer station, and reordering to obtain a vertical data sample composed of a total load power and meteorology data at the same time on the same date in different months;
establishing a load-meteorology nonlinear association model between the total load power, the meteorology sensitive load power, and various pieces of meteorological information, and identifying model parameters by using a gradient method; and
substituting the identified model parameters, longitudinal historical meteorology data, and total load power data into the association model, calculating a longitudinal meteorology sensitive load power curve, and arranging according to a normal time sequence to obtain a historical daily meteorology sensitive load power curve.
